(19) United States
(12) Patent Application Publication
(10) Pub. No.: US 2006/0259891 A1
(43) Pub. Date: Nov. 16, 2006

(54) System and method of generating an auto-wiring script

(76) Inventor: Wei-Fan Ting, Taipei (TW)

Correspondence Address: RABIN & Berdo, PC, 1101 14TH STREET, NW, SUITE 500, WASHINGTON, DC, 20005, US

(21) Appl. No.: 11/125,140

(22) Filed: May 10, 2005

(51) Int. Cl. G06F 17/50

(52) U.S. Cl. 716/11; 716/12

(57) ABSTRACT

A system and method of generating an auto-wiring script, which can be utilized to generate a script used exclusively for the wiring software according to corresponding table specifying the relations between the net names and the electrical constraint sets and the files of other related attributes. The wiring software can be used to perform automatic circuit design by making use of said script, and the errors may be corrected real time according to the error messages caused by applying said auto-wiring script on the newly designed circuit board design drawing file.

### BACKGROUND OF THE INVENTION

1. Field of the Invention

The invention relates to a system and method of generating an auto-wiring script, in particular to a system and method of generating an auto-wiring script based on the corresponding table and other related files provided by the user.

2. Related Art

In recent years, due to the increasing complexity of the design of electronic products, the application and utilization of a convenient and powerful Electronic Design Automation (EDA) system has been essential and increasingly important. At present, Cadence Design System Inc is one of the major suppliers of electronic design technologies, procedure planning and development, with its service and products covering the entire process flow of electronic product design. Among them, Allegro is a set of platforms mainly used for the wiring layout design of a multi layer printed circuit board (PCB). Allegro has been very popular and widely used, due to its benefits and advantages of easy-utilization, easy-modification, and being highly compatible with other related software. Besides, it can be utilized by the user to develop the related software according to his/her own actual requirements.

In the past, when designing a system, the hardware engineer was usually required to list the itemized design requirements item-by-item, which were then input to the engineer of the multi-layer PCB for subsequent detailed design. However, for the complicated electronic system with tens of thousands of wirings and restrictions, it is very difficult if not impossible to achieve complete and flawless management and implementation of the related designs. To overcome this problem and restriction, a Constraint Manager (CM) is provided in Allegro, which can be utilized by the design engineer to define the Electrical Constraint Set (EC set) required, according to the relation, and constraint between the wiring pattern and the length of the signal wire. As such, the Electrical Constraint Set thus designed is used to enable the wiring software to automatically detect and determine whether the wiring design is compatible with the requirements of the rules, by making use of the Design Rule Check (DRC). Thus, not only the time spent on the electronic product design can be saved, but the probability of error can also be significantly reduced.

Though the Electrical Constraint Set could be utilized to define and specify the relation between the wiring pattern and the length of the signal wire, since the multi layer PCB is composed of thousands of nets, it would be very tedious and time-consuming to define and specify the related Electrical Constraint Set corresponding to each of the nets depending on the actual requirements of the new product, by making use of the Constraint Manager.

Fortunately, Allegro is provided with the Electrical Constraint Set and the file export of the Electrical Constraint File (dcf file) recorded with the corresponding relations between each net and the Electrical Constraint Set (EC set), so that the previously set related design can be utilized to revise the attributed data in the electrical constraint set and the corresponding relations in the electrical constraint file. The proceedings above are all carried out within the Constraint Manager, yet problems and difficulties still exist. For example, after making the necessary revisions, the revised Electrical Constraint Set must be applied on the basic unit for example nets or Xnets desired to be controlled. Yet in the interface of the Control Manager, the nets or Xnets are imbedded in each of the corresponding buses, so that each bus must first be exploded one-by-one, to locate the net of Xnets to be revised. Due to the fact that there are thousands of nets or Xnets at present provided in the main circuit board, it is rather inconvenient to utilize the settings of the previous design repeatedly in this manner.

### SUMMARY OF THE INVENTION

In view of the above-mentioned problems and shortcomings of the prior art, the object of the invention is to provide a system and method of generating an auto-wiring script, which could be a stand alone type device utilized to operate independently of Allegro, and retrieve the attribute and the corresponding relations contained therein by making use of the function provided by Allegro, to export the electrical constraint set and the electrical constraint file. The invention is based on the corresponding table specifying the relations between the net and electrical constraint set by the user, and combining it with the above-mentioned two data to form the script file required in operating on the automatic wiring software.

Upon the completion of revising the various corresponding relations outside the wiring software, the script file utilized by the above-mentioned Allegro is exported by making use of the script import function provided by Allegro, and the related electrical constraints are automatically applied on the corresponding net or Xnet after executing the script. Then the error message file generated by this application is rearranged into an interface which is much more easily indexed and accessible, as such capable of revising the Electrical Constraint Set real time.

To achieve and realize the object of the system for generating the auto-wiring script of the invention, the following devices are indispensable: a retrieving unit, which is used to retrieve the net name of said respective set files, attribute contents of the Electrical Constraint Set, the corresponding relations between the two, and the contents of the error recording file; a script generation unit, which is used to integrate the data previously retrieved by the retrieving unit to generate the auto-wiring script, that can be applied on the wiring software; a display unit, which is used to provide the operation interface enabling the user to select the electrical constraint file and display the error recording file; a revision unit, which is used to provide the revision interface real time for the error message displayed by the display unit.

In addition, the scanning method provided by the bi-directional scanning system of the invention comprises the following steps.

The user selects the reusable corresponding table, the previously designed circuit board design drawing file, the electrical constraint file, and the directory of the revised electrical constrain sets. Next, generates a script applicable on the wiring software. Then, generates a script applicable on the wiring software. Subsequently, generates the error message report by applying the script on the newly designed circuit board design drawing file. Finally, implements the corresponding revision regarding said error message report.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below, which is for illustration only and thus is not limitative of the present invention, wherein:

FIG. 1 is a schematic diagram of the system structure of the system of generating the auto-wiring script of the invention;

FIG. 2 is a flowchart of the method of generating the auto-wiring script of the invention;

FIG. 3 is a flowchart illustrating generating the new corresponding table based on the previously designed corresponding table and the electrical constraint file according to the method of the invention; and

FIG. 4 is a flowchart illustrating generating the new electrical constraint set, based on the error message caused by applying the auto-wiring script on the newly designed circuit board design drawing file according to the method of the invention.

### DETAILED DESCRIPTION OF THE INVENTION

The purpose, construction, features, and functions of the present invention can be appreciated and understood further through the following detailed description with reference to the attached drawings.

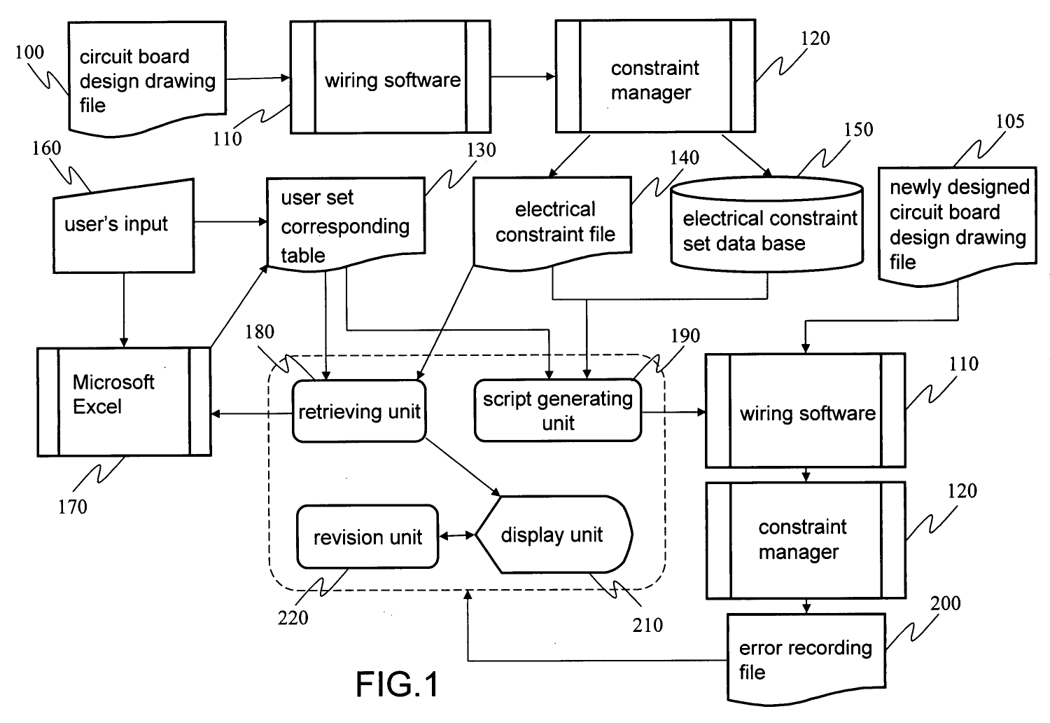

Refer to FIG. 1 for the system structure diagram of the invention. In order to generate a wiring script applicable on the wiring software 110, the previously designed circuit board design drawing file 100 is utilized to generate two electrical related files through the Constraint Manager 120 in the wiring software 110: an electrical constraint file 140, in which the corresponding relations between each net on the electrical circuit board and the Electrical Constraint Set are recorded, and an electrical constraint data base 150, in which the constraints, considered for the disposition of each element on the circuit board, are recorded.

In addition to those two files, the generation of the Automatic Wiring Macro Set requires a user set corresponding table 130 recorded with the relations between each net on the newly designed circuit board and the Electrical Constraint Set. Said corresponding table 130 may be generated by means of the following two methods: in the first method, it is entirely done by the user's manual input 160, which is the same as is done in the prior art. The respective net and its corresponding Electrical Constraint Set are defined and set one-by-one by the user through the Constraint Manager 120. As mentioned earlier, this method proves to be tedious, cumbersome, and time consuming.

Alternatively, in the second method, the corresponding table 130, previously set by the user in designing the circuit board, and the previously designed electrical constraint file 140 are utilized to retrieve the corresponding relation between the net name and the corresponding electrical constraint set through the retrieving unit 180, and store it into the Excel file. In Microsoft Excel 170, the user is enabled to make revisions regarding the portions that are different from the previous design, for example, the revisions concerning the electrical constraint values, the name of the internal elements, and the names of the nets. Upon the inspection of Excel, the tree structures of said relations created by the Constraint Manager 120 are broken to facilitate the inspection and revision of the user.

In addition, the Excel file may be sorted according to the names of the nets, since the respective net has different circuit- and element attributes and their related rules of definitions. Thus the name of the respective net may be defined in accordance with the specific naming rule to facilitate the inspection and revision of the user, so that the nets of the same attribute will gather together after sorting, thus the user does not have to worry about ignoring any incomplete revisions.

Concerning the naming rules, the naming of the electrical constraint set is taken as an example. Supposing that the file name of an electrical constraint set is “PCI-g13.top”, from the former portion “PCI” it is known that said electrical constraint set is utilized to define the electrical constraints for the insertion slot or the chip in the PCI bus.

Based on this naming rule, a regulation expression method may be utilized to select the file by its name, and the net name of similar property may be represented by a regular expression, for example, the “PCI-g***” is utilized to represent all the net names related to the PCI bus, thus the resulting decrease of the number of net names could facilitate their inspections and revisions by the users.

Furthermore, the error recoding file 200 generated by applying the newly designed circuit board design drawing file 105 on the auto-wiring script could be used to retrieve the field of the net name and the corresponding Electrical Constraint Set and the net of the Xnets relating to the error, and the error message is itemized and then displayed, thus facilitating its reading and direct revision by the user.

Subsequently, upon the completion of the user set corresponding table 130, it is input to the system of the invention as indicated by the dashed line in FIG. 1, together with the Electrical Constraint File 140 and the Electrical Constraint Set. The macro set generation unit 190 is used to generate a script file having suffix “.scr” of the file name according to the name of the net, the name of the internal element attribute, the corresponding electrical constraint set, and the electrical constraint value retrieved from the above-mentioned three input sources.

The display unit 210 is used to provide the operation interface for the user to select the various electrical set files, thus to display the circuit board design drawing file 100, and the error messages in the error recording file 200 resulting from any error caused by applying said drawing file 105 on the Auto-wiring script.

The error messages are then itemized in the Retrieving Unit 180 and displayed by the Display Unit 210.

Besides displaying the itemized error messages of the error recording file 200, the Display Unit 210 may be utilized by the user to directly click and select the erroneous net name or the electrical constraint set and the attribute values contained therein. The revision unit 220 is used to read the clicked and selected elements and the attributed values contained in the electrical constraint set, and the related graphic display, and implement the revisions directly regarding the related error portions. Upon completion of the revision, the revised electrical constraint set and the corresponding table 130 are again input in the system of the invention for generating the auto-wiring script file.

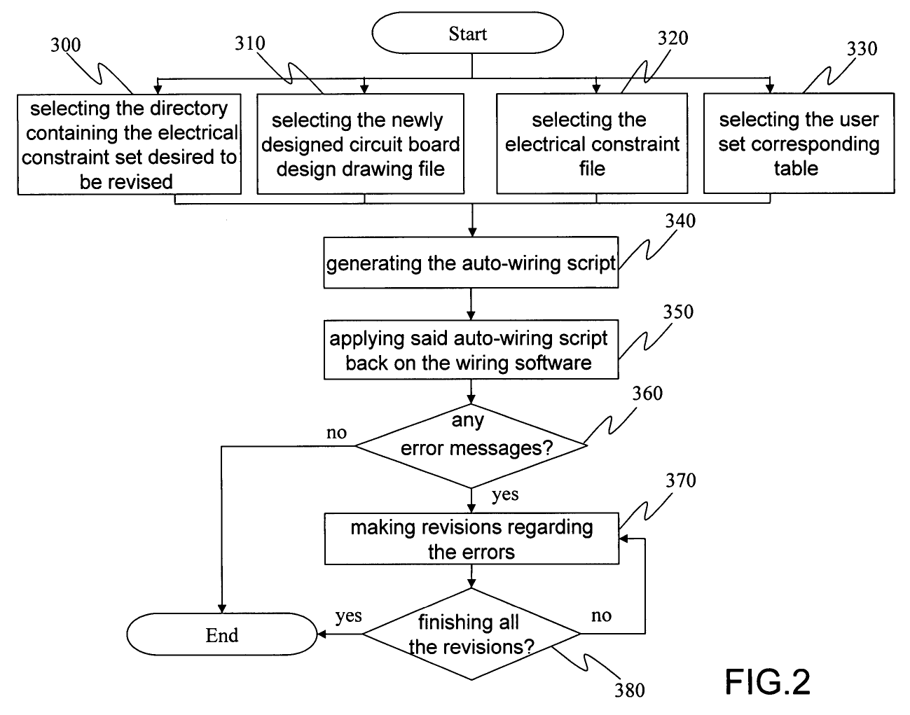

Then, refer to FIG. 2 for the description of the flowchart of the method of generating the auto-wiring script of the invention. As shown in FIG. 2, firstly, the user selects the directory containing the file names of the revised electrical constraint file and applies the revised previous electrical constraint set on the new design (step 300). Next, selects the new circuit board design drawing file (step 310), and applies the previous electrical constraint set on it to see if there is any error. Then selects the electrical constraint file (step 320) for generating the new corresponding table. Subsequently, selects the corresponding table set (step 330)

Finally, generates the auto-wiring script file corresponding to the net name and the electric constraint set (step 340).

Further, the user applies the auto-wiring script back on the wiring software (step 350); checks to see if there are any errors, and if there is no error then the system flow ends (step 360). Otherwise, revises the errors, showing, on the revision unit 220, the internal elements, attribute values of the Electrical Constraint Set and their relations, to click and select them, directly making revisions, required until all the errors are corrected (step 380).

In the above description, the method utilized in revising the corresponding table designed previously by the users includes the following steps.

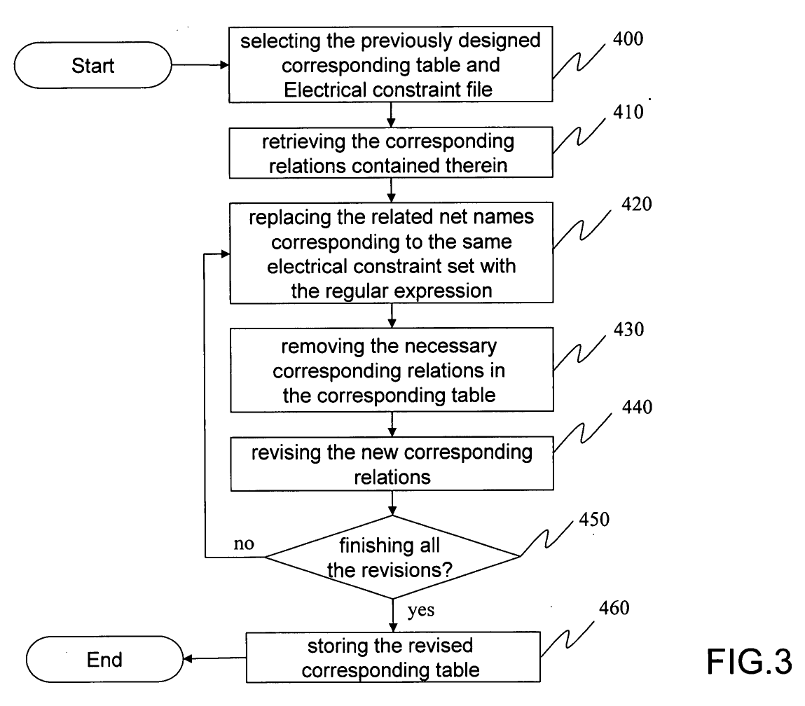

Refer to FIG. 3, firstly, The user selects the previously designed electric constraint file and the corresponding table of the similar electronic products (step 400), since the improvement of the designs of most of the electronic products are based on those of the previous designs. Therefore, most of the preset files of the previous design may be used by the present design, and there is no need to re-enter all the related data from the scratch all over again, thus a lot of time in product design and development is saved.

In the previous design, all the revisions were made through the Constraint Manager (CM)120. However, using the interface, provided by CM120, for a large number of revisions is not convenient. As such, the pertinent steps adopted by the method of the invention are as follows.

Firstly, retrieving the corresponding relations concerning the design elements of the corresponding table into an Excel list (step 410) and displaying its contents in Excel format. Thus they can be sorted according to their names, so that the design elements of the same net or electric constraint set can be gathered together. Next, replacing the related net name by making use of the regular expression, thus saving the effort spent on setting the net names (step 420).

Then, removing the duplicate corresponding relations in the list, so that the corresponding list is much easier for inspection and revision (step 430); next, adding and/or revising the net names and their corresponding relations of the Electric Constraint Set as required by the new design (step 440); further, verifying the completion of all the additions/revisions (step 450); finally, storing said corresponding table in the related memory to complete the revision of the corresponding table (step 460).

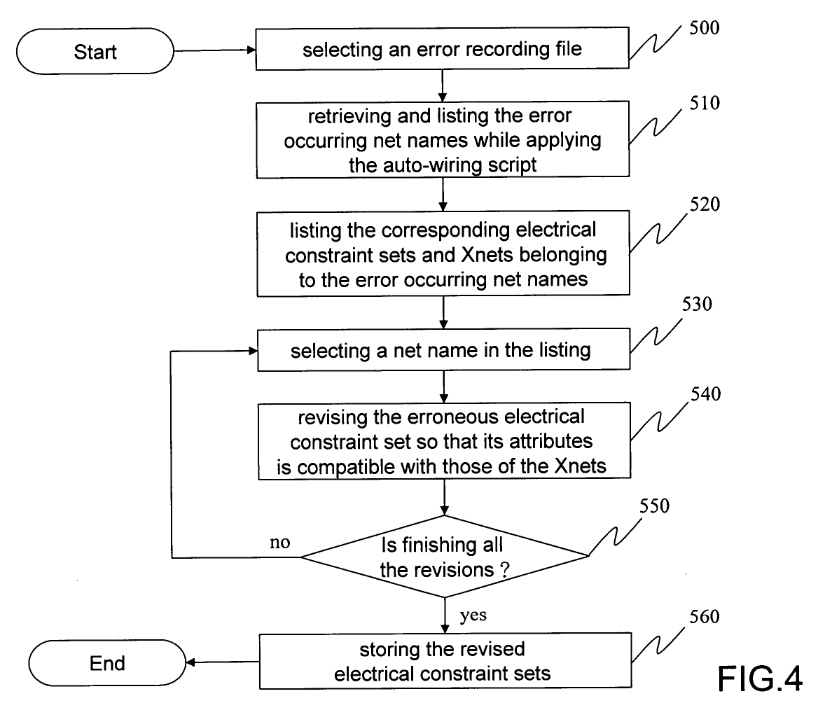

Subsequently, refer to FIG. 4 for the flowchart of displaying and correcting the electric constraint set, based on the error recording file according to the embodiment of the invention. When the auto-wiring script is applied on the newly designed circuit board design drawing file 105, the error messages of any discrepancy are stored in the error recording file. However, usually, the error messages generated by the wiring software 110 are composed of characters only, which need to be rearranged and recompiled, to facilitate reading and revision. As such, the error messages generated by the above method must be subjected to the processing of the following steps.

Firstly, selecting the error recording file 200 generated by applying the auto-wiring script on the newly designed circuit board design drawing file 105 (step 500); next, making use of the retrieving unit 180 to retrieve and list the erroneous net names in the error recording file 200 (step 510). Then, listing the corresponding erroneous electric constraint set, nets or Xnets belonging to said net name (step 520). Subsequently, selecting a net name in the list (step 530); further, revising the erroneous items in said electrical constraint set, so that it corresponds to the attributes of the nets or Xnets(step 540), until finishing receiving all the erroneous net names and the corresponding items in the electric constraint set (step 550). Finally, storing the revised electrical constraint set in the related memory (step 560), thus completing the revision process.

Knowing the invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An auto-wiring script generation system, which is used to combine a plurality of preset files of: a corresponding table indicating the relations between the net names and the electrical constraint sets, an electric constraint file, and an electric constraint set data base, etc., for generating an auto-wiring script applied on a wiring software, comprising:
a retrieving unit, used to retrieve the net name of said set file, the attribute contents of the electrical constraint set and the relations therebetween, and the contents of the error recording file respectively;
a script generation unit, used to integrate the information retrieved by the retrieving unit for generating an auto-wiring script;
a display unit, used to provide an operation interface to enable the user to select said respective set file, and display the error recording file; and
a revision unit, used to provide a graphic interface for updating real time said error recording file displayed by said display unit, thus facilitating the user to update real time the contents of said respective erroneous electrical constraint set.

2. The auto-wiring script generation system as claimed in claim 1, wherein
said retrieving unit is used to retrieve the corresponding relations between the items of said corresponding table previously set by said user and said electrical constraint file, and to display them in Excel format.

3. The auto-wiring script generation system as claimed in claim 1, wherein
said corresponding table is obtained by retrieving and then revising by the user the previously designed corresponding table.

4. The auto-wiring script generation system as claimed in claim 1, wherein
said respective electrical constraint file is exported by the Constraint Manager based on the previously designed circuit board design drawing file.

5. The auto-wiring script generation system as claimed in claim 1, wherein
said respective electrical constraint set is exported by said Constraint Manager.

6. The auto-wiring script generation system as claimed in claim 1, wherein
said plurality of net names corresponding to the same electrical constraint set are replaced by the net names of regulation expression.

7. The auto-wiring script generation system as claimed in claim 1, wherein
said error recording file is generated by the errors caused by applying said auto-wiring script on the newly designed circuit board design drawing file.

8. The auto-wiring script generation system as claimed in claim 1, wherein
said revision unit is used to output said respective revised set file to the present system after the completion of the revision by the user, thus regenerating said auto-wiring script.

9. An auto-wiring script generating method, comprising the following steps:
selecting by the user the previously designed circuit board design drawing file;
setting a corresponding table specifying the relations between the net names and a plurality of electrical constraint sets;
selecting the electrical constraint file exported by the wiring software;
selecting a directory storing the names of said respective revised electric constraint sets;
generating a script file applicable on said wiring software; and
generating a return message by applying said script file on the newly designed circuit board design drawing file.

10. The auto-wiring script generation method as claimed in claim 9, wherein
said corresponding table can be input by the user manually.

11. The auto-wiring script generation method as claimed in claim 9, wherein
said corresponding table is obtained by retrieving and then revising by the user the previously designed corresponding table.

12. The auto-wiring script generation method as claimed in claim 11, wherein
said revising the previously designed corresponding table includes the following steps:
selecting said previously designed corresponding table and said electric constraint file;
retrieving said respective corresponding relations set in said corresponding table to form an Excel listing;
removing the unnecessary plurality of corresponding relations from said listing;
replacing the plurality of net names corresponding to the same electrical constraint set with a regular expression; and
storing said corresponding table after the completion of its revision.

13. The auto-wiring script generation method as claimed in claim 9, wherein
said electrical constraint file is exported by the Constraint Manager based on the previously designed circuit board design drawing file.

14. The auto-wiring script generation method as claimed in claim 9, wherein
said respective electrical constraint set is exported by said Constraint Manager.

15. The auto-wiring script generation method as claimed in claim 9, wherein
a returned error message is generated by the error caused by applying said auto-wiring script on the newly designed circuit board design drawing file.

16. The auto-wiring script generation method as claimed in claim 15, wherein revising the attribute setting and its set value based on the returned error message includes the following steps:
selecting the error recording file;
retrieving and listing the plurality of erroneous net names, listing said respective electrical constraint set and Xnet corresponding to said respective erroneous net name;
selecting said respective net name from said list one-by-one, revising said respective electrical constraint set, such that its attribute is compatible with that of the Xnet; and
storing said respective electrical constraint set in the memory after completing its revision.

17. The auto-wiring script generation method as claimed in claim 16, wherein
said error recording file is generated by the errors caused by applying said auto-wiring script on the newly designed circuit board design drawing file.
